(19) United States
(12) Patent Application Publication
(10) Pub. No.: US 2012/0087383 A1
(43) Pub. Date: Apr. 12, 2012

(54) BONDED PERIODICALLY POLED OPTICAL NONLINEAR CRYSTALS

(76) Inventors: Ye Hu, Dundas (CA); Wanguo Liang, Hamilton (CA)

(21) Appl. No.: 13/377,633

(22) PCT Filed: Sep. 29, 2010
(86) PCT No.: PCT/CN10/77462

§ 371 Date: Dec. 12, 2011

Related U.S. Application Data
(60) Provisional application No. 61/249,501, filed on Oct. 7, 2009.

(51) Int. Cl. H01S 3/10; B32B 37/14

(52) U.S. Cl. 372/21; 156/60

(57) ABSTRACT

A method for designing optimized length of a nonlinear crystal (3) with a bonded structure is provided. Also provided are a method for forming a short Quasi-Phase Matching (QPM) crystal (3) sandwiched by non-poled nonlinear crystals (2, 4), and a method for designing multiple-section periodically poled nonlinear crystal with a high temperature, while keeping sufficient long crystal length and high conversion efficiency.

### 1. FIELD OF THE INVENTION

The present invention relates to design of a bonded optical nonlinear crystal based on the quasiphase matching (QPM) technique, which can be used to generate light in a wavelength range from UV to mid-IR.

### 2. DESCRIPTION OF THE RELATED ART

In the development of the second harmonic (SHG) lasers based the QPM optical nonlinear crystals, optimized design of the QPM crystals is necessary. One example of the diode pumped solid state (DPSS) SHG lasers is disclosed in a literature (S. W. Chu, et al., “High-Efficiency Intra-cavity Continuous-Wave Green-Light Generation by Quasiphase Matching in a Bulk Periodically Poled MgO:LiNbO₃ Crystal”, Advances in OptoElectronics, Volume 2008 (2008).) In this literature, a SHG laser is formed by a pump laser diode 1, a laser crystal 2, a QPM crystal 3, and an optical output coupling mirror 4, as shown in FIG. 1. The facets of the laser crystal and the QPM crystal are properly coated with either high reflection (HR) or anti-reflection (AR) films 5, 6, 7, 8 so that the fundamental light is confined in the laser cavity while the SHG light is coupled out the laser cavity efficiently. The QPM crystal acts as a second harmonic generator in which a periodical domain inversion grating is formed along the grating direction so as to satisfy the QPM condition. By pumping a laser crystal (i.e. Nd doped YVO₄) with a pump laser diode with a lasing wavelength of 808 nm, fundamental light of a wavelength λ (i.e. 1064 nm) is generated within a laser cavity. If the period of the QPM crystal is selected properly so that the QPM wavelength of the nonlinear crystal matches with the fundamental wavelength, a second harmonic light at a wavelength of λ/2 (i.e. 532 nm) can be generated efficiently. The period of the domain inversion grating Λ is decided by the QPM condition (i.e. 2(n_{2ω}−n_{ω})=λ/Λ, where n_{2ω} and n_{ω} are refractive indices at SH and fundamental light, respectively).

To achieve efficient wavelength conversions, reduce size and packaging cost of the lasers, a bonded structure is usually employed, in which the laser crystal 2 and nonlinear crystal 3 is bonded together, as shown in FIG. 2. To confine the fundamental light within the laser cavity, reduce coupling loss of pump power and couple SH light efficiently from the cavity, the laser crystal 3 is coated with a film 1, which has HR at wavelengths of fundamental and SH light (e.g. 1064 nm and 532 nm) but AR at the wavelength of the pumping light (e.g. 808 nm), while nonlinear crystal 3 is coated with a film 4, which has HR at fundamental light (e.g. 1064 nm) and AR at SH light (e.g. 532 nm)

In fact, the above described technique using the bonded nonlinear crystal is well known and has been disclosed in a number of literatures, such as Mooradian, et al., U.S. Pat. No. 4,953, 166, Microchip laser, Feb. 9, 1989; J. J. Zayhowski et al., “Diode-pumped passively Q-switched picosecond microchip lasers”, Optics Letters, vol. 19, p. 1427 (1994); R. Fluck, et al., “Passively Q-switched 1.34-micron Nd:YVO₄ microchip laser with semiconductor saturable-absorber mirrors,” Optics Letters, vol. 22, p. 991 (1997); U.S. Pat. No. 5,295,146, Mar. 15, 1994. Gavrilovic, et al., Solid state gain mediums for optically pumped monolithic laser; U.S. Pat. No. 5,574,740, Aug. 23, 1994. Hargis, et al., Deep blue microlaser; U.S. Pat. No. 5,802,086, Sep. 1, 1998. Hargis, et al., High-efficiency cavity doubling laser; U.S. Pat. No. 7,149,231, Dec. 12, 2006. Afzal, et al., Monolithic, side-pumped, passively Q-switched solid-state laser; U.S. Pat. No. 7,260,133, Aug. 21, 2007. Lei, et al., Diode-pumped laser; U.S. Pat. No. 7,535,937, May 19, 2009. Luo, et al., Monolithic microchip laser with intra-cavity beam combining and sum frequency or difference frequency mixing; U.S. Pat. No. 7,535,938, May 19, 2009; Luo, et al., Low-noise monolithic microchip lasers capable of producing wavelengths ranging from IR to UV based on efficient and cost-effective frequency conversion; U.S. Pat. No. 7,570,676, Aug. 4, 2009. Essaian, et al., Compact efficient and robust ultraviolet solid-state laser sources based on nonlinear frequency conversion in periodically poled materials; USPC Class: 372 10, IPC8 Class: AH01S311FI, Essaian, et al.; R. F. Wu, et al., “High-power diffusion-bonded walk-off-compensated KTP OPO”, Proc. SPIE, Vol. 4595, 115 (2001); Y. J. Ma, et al., “Single-longitudinal mode Nd:YVO₄ microchip laser with orthogonal-polarization bidirectional traveling-waves mode”, 10 Nov. 2008, Vol. 16, No. 23, OPTICS EXPRESS 18702; C. S. Jung, et al., “A Compact Diode-Pumped Microchip Green Light Source with a Built-in Thermoelectric Element”, Applied Physics Express 1 (2008) 062005.

The bonding can be achieved by using either adhesive epoxy or the direct bonding technique. The bonded nonlinear crystal can be traditional nonlinear crystal such as KTP or periodically poled crystal such as PPLN. The laser employing the bonded nonlinear crystal can either based on second harmonic generation (SHG) or sum frequency generation (SFG) or difference frequency generation (DFG).

However, bonded structure using KTP crystal has several drawbacks. First, effective nonlinear coefficient of KTP is relatively low (˜3.5 pm/V). As a result, a relatively long KTP crystal (e.g. 5˜10 mm) has to be used to achieve high output of the SHG lasers (e.g. >100 mW), which increases size and cost of the lasers. Second, KTP has relatively low optical damage threshold, limiting the output power of the SHG lasers. Third, KTP is not suitable for UV laser since it is impossible for KTP to find a phase matching condition for UV light generation.

To overcome the problems mentioned above, a bonded structure using periodically poled (PP) crystal has been proposed. MgO doped periodically poled lithium niobate (MgO:PPLN) is considered especially promising candidate to replace KTP since it has several advantages over the other nonlinear crystals. First, MgO:PPLN has much higher effective nonlinear coefficient (˜17 μm/V). Second, MgO:PPLN has very high optical damage threshold. Third, MgO:PPLN can be used to generate light over the entire transparent wavelength range (350 nm˜4500 nm) The phase matching condition can easily be satisfied by selecting proper period of the domain inversion structure in MgO:PPLN.

Although the idea of using a bonded nonlinear crystal in the DPSS SHG laser has been disclosed, some important questions on nonlinear crystal design have not been answered yet, such as how long the nonlinear crystal we should use and what the period should be set if a periodically poled crystal is used.

### 3. SUMMARY OF THE INVENTION

The objective of the present invention is to provide a method to determine the length of the nonlinear crystal with a bonded structure in the DPSS SHG lasers, which has significant impact on the laser performance. In this method, round trip loss of the nonlinear crystal and temperature difference at the two ends of the nonlinear crystal are taken into account, and an optimized nonlinear crystal length is decided. Another objective of the present invention is to provide methods to achieve a very short nonlinear crystal which actually contributes to SHG lasers. Yet another objective of the present invention is to provide methods to achieve efficient lasers with broad operation temperature range.

According to one aspect of the present invention, as shown in FIG. 4, a nonlinear crystal with one QPM region 3 (e.g. MgO:PPLN) and two un-poled regions 2, 4 (e.g. MgO doped LN) is bonded with a laser crystal 1. The facets of the laser crystal and the QPM crystal are properly coated with either high reflection (HR) or anti-reflection (AR) films 5, 6 so that the fundamental light is confined in the laser cavity while the SHG light is couple out the laser cavity efficiently. The second harmonic generation occurs only in the QPM region 3 in which the QPM condition is satisfied. By pumping a laser crystal (i.e. Nd doped YVO₄) with a pump laser diode with a lasing wavelength of 808 nm, fundamental light of a wavelength λ (i.e. 1064 nm) is generated within a laser cavity. If the period of the QPM crystal is selected properly so that the QPM wavelength of the nonlinear crystal matches with the fundamental wavelength, a second harmonic light at a wavelength of λ/2 (i.e. 532 nm) can be generated efficiently. The period of the domain inversion grating Λ is decided by the QPM condition (i.e. 2(n_{2ω}−n_{ω})=λ/Λ, where n_{2ω} and n_{ω} are refractive indices at SH and fundamental light, respectively).

### 4. BRIEF DESCRIPTION OF THE DRAWINGS

The present invention will be understood more fully from the detailed description given herein below, taken in conjunction with the accompanying drawings.

In the drawings:

FIG. 1 is a schematic drawing of a prior art of a DPSS SHG laser.

FIG. 2 is a schematic drawing of a prior art of a nonlinear crystal with a bonded structure for a DPSS SHG laser.

FIG. 3 is a schematic drawing of a prior art of a MgO:PPLN nonlinear crystal with a bonded Nd:YVO4 laser crystal for a DPSS SHG laser.

FIG. 4 is a schematic diagram for explaining the concept of one method to achieve short nonlinear crystal with a bonded structure according to the present invention.

FIG. 5 is a schematic diagram for explaining the concept of the method described in the first preferred embodiment to determine the optimized length of the bonded nonlinear crystal with a QPM structure according to the present invention.

FIG. 6 is a schematic diagram for explaining the concept of the method described in the second preferred embodiment to determine period of the bonded nonlinear crystal with a QPM structure according to the present invention.

FIG. 7 is a schematic diagram for explaining the concept of the method described in the third preferred embodiment to form a short nonlinear crystal with a QPM structure according to the present invention.

FIG. 8 is a schematic diagram for explaining the concept of the method described in the forth preferred embodiment to form an efficient nonlinear crystal with multiple QPM structures according to the present invention.

FIG. 9 is a schematic diagram for explaining the concept of the method described in the forth preferred embodiment to tune optical length of the phase adjustment sections according to the present invention.

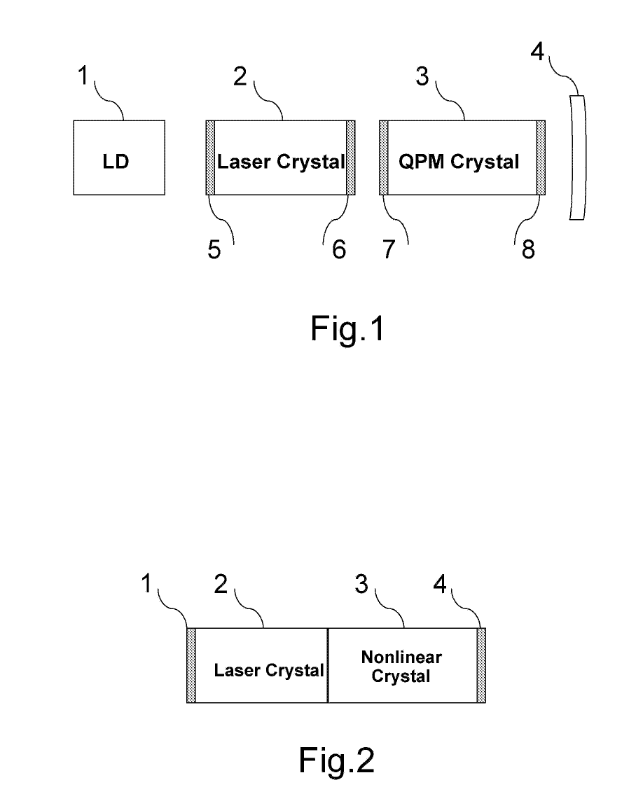

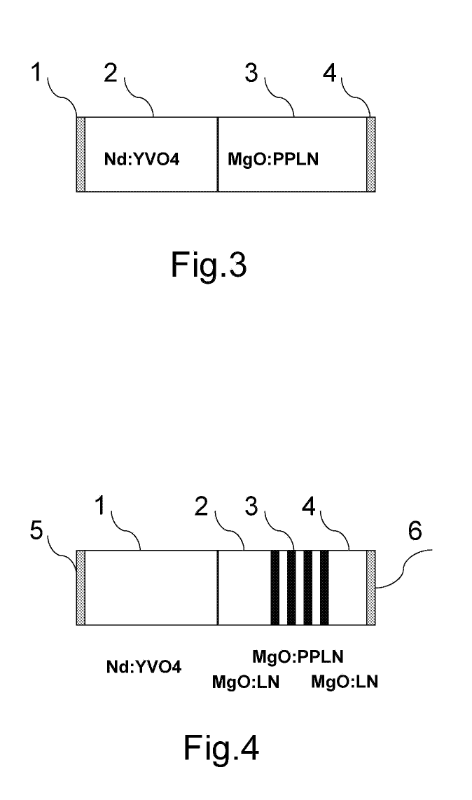

### 5. DETAILED DESCRIPTION OF PREFERRED EMBODIMENTS

The present invention solves the foregoing problems by means described below.

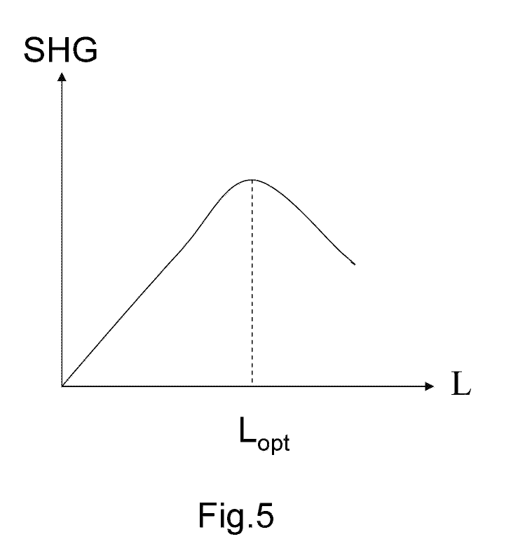

In the first preferred embodiment, as shown in FIG. 5, a preferred length of the bonded nonlinear crystal with a QPM structure. In the SHG laser with an intra-cavity configuration, SH light output from the laser is determined by a number of factors such as length of the bonded nonlinear crystal, optical power launched into the laser crystal, beam diameter of the fundamental light confined within the laser cavity. Under the ideal conditions, i.e. the nonlinear crystal has no loss and the beam diameter remains a constant within the nonlinear crystal at the fundamental wavelength, the longer the nonlinear crystal, the higher SH light power we can obtain from the SHG laser. However, the length of the nonlinear crystal with a QPM structure is limited by the following factors. First, when the nonlinear crystal is bonded with a laser crystal, the nonlinear crystal adjacent to the laser crystal has higher temperature and the nonlinear crystal away from the laser crystal has lower temperature since the laser crystal absorbs light from the pumping laser diode and thus increases its temperature. The temperature of the laser crystal is dependent on the pumping power of the pumping laser diode. On the other hand, the operation temperature range of the nonlinear crystal with a QPM structure is determined by the length of the nonlinear crystal. For example, the full width at half maximum (FWHM) operation temperature range is about 3° C. for a 5 mm-long MgO:PPLN. As a result, if the temperature difference between the two ends of the boned nonlinear crystal is larger than 3° C., length of the bonded nonlinear crystal has to be set far below 5 mm. Second, scattering and absorption within the crystal and reflection loss at the end facets of the nonlinear crystal also limit the length of the bonded nonlinear crystal in the intra-cavity configuration. Third, to keep a uniform beam diameter within the entire nonlinear crystal, the smaller the beam diameter, the shorter the nonlinear crystal must be. Small beam diameter is usually preferred for efficient SHG since high optical intensity can be achieved which is essential for SHG process. Last, employing a short nonlinear crystal means the low cost.

Based on the description above, it is easy to understand that there exists an optimized length for the bonded nonlinear crystal with a QPM structure, as shown in FIG. 5. The optimized length is dependent on the pumping power from the pumping laser diode in the SHG laser with the intra-cavity configuration. Experimentally, it is found that for MgO:PPLN bonded with Nd:YVO4 with 500 mW pumping at a wavelength of 808 nm wavelength, the optimized length of MgO:PPLN is 1.0 mm+/−0.5 mm. However, the optimized length of MgO:PPLN is reduced to 0.5 mm+/−0.3 mm if 3 W pumping at 808 nm is used due to the increase of laser crystal temperature.

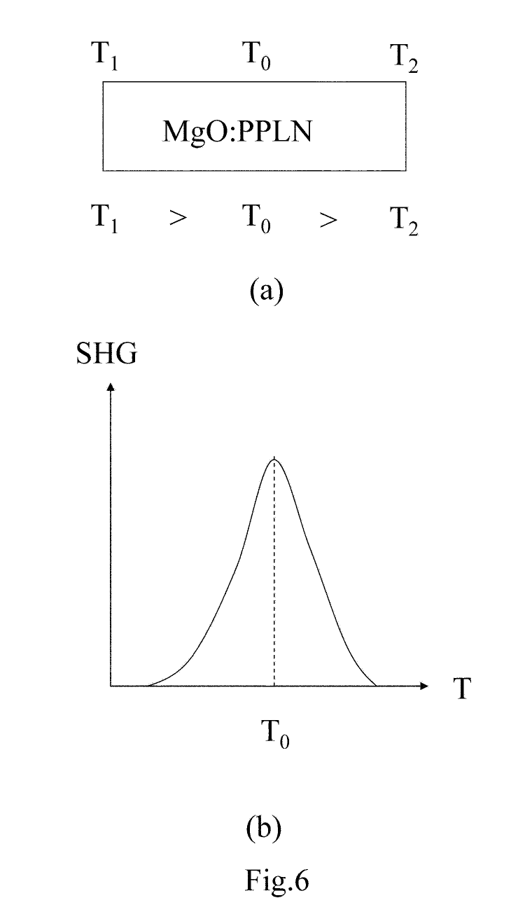

In the second preferred embodiment of the present invention, as shown in FIG. 6, the period of the MgO:PPLN is set at a period so that the corresponding QPM temperature T_{QPM} is equal to the average temperature (T₁+T₂)/2, where T₁ and T₂ are temperature at the two end of the MgO:PPLN crystal. As described in the first preferred embodiment, T₁ is determined by the pumping power of the 808 nm pumping laser diode, while T₂ is related to MgO:PPLN crystal length. For example, for 1.0 mm-long MgO:PPLN bonded with Nd:YVO4 with 500 mW pumping at a wavelength of 808 nm wavelength, the preferred QPM temperature T_{QPM} of MgO:PPLN is 30+/−5° C.

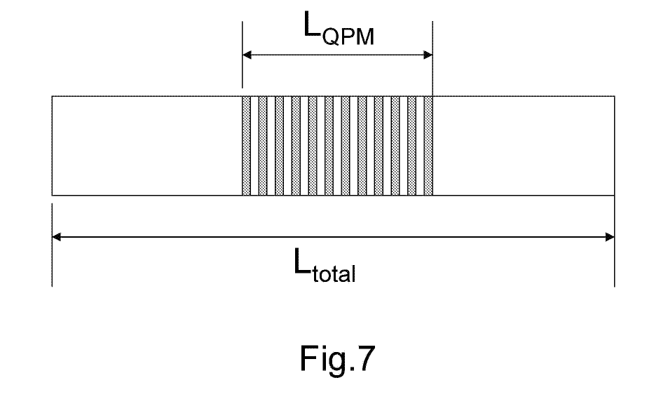

In the third preferred embodiment of the present invention, a method of forming a short nonlinear crystal with a QPM structure is presented, as shown in FIG. 7. From facet polishing and bonding point of view, the nonlinear crystal cannot be too short. On the other hand, as described in the first preferred embodiment, in some cases, a short nonlinear crystal (e.g. 0.5 mm) is desirable. The QPM structure with periodical domain inversion is formed only in certain region of the nonlinear crystal, while the rest of the nonlinear crystal is not periodically poled. As a result, SHG occurs only in the region with the QPM structure. The QPM structure can be set at the center of the nonlinear crystal. The total length of the nonlinear crystal can be set at a length that can easily be handled in the facet polishing and bonding processes.

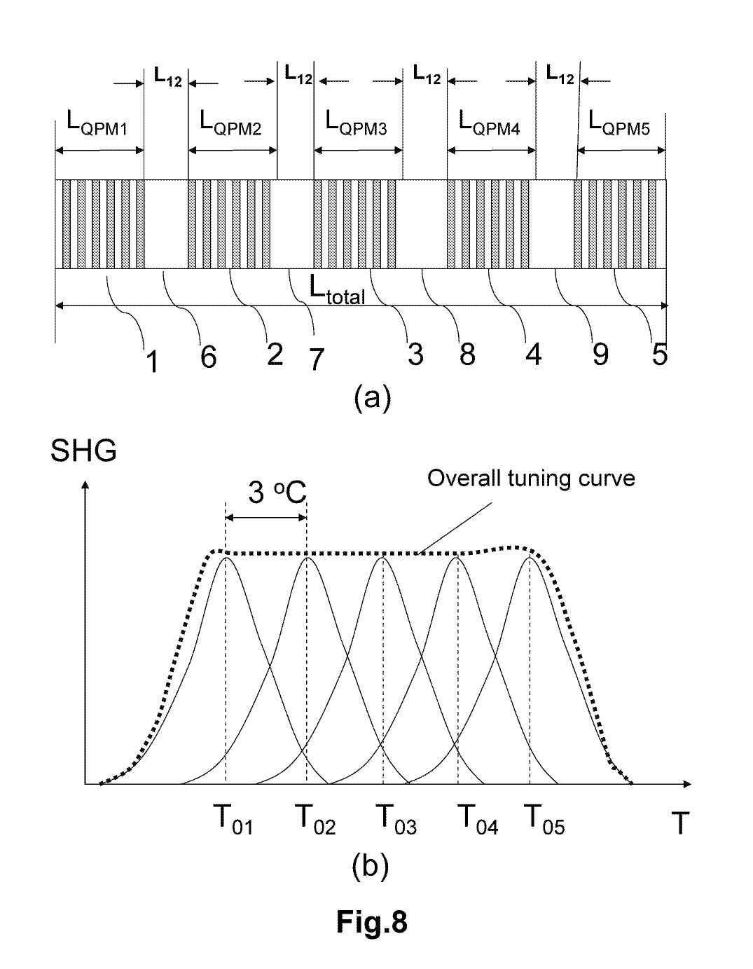

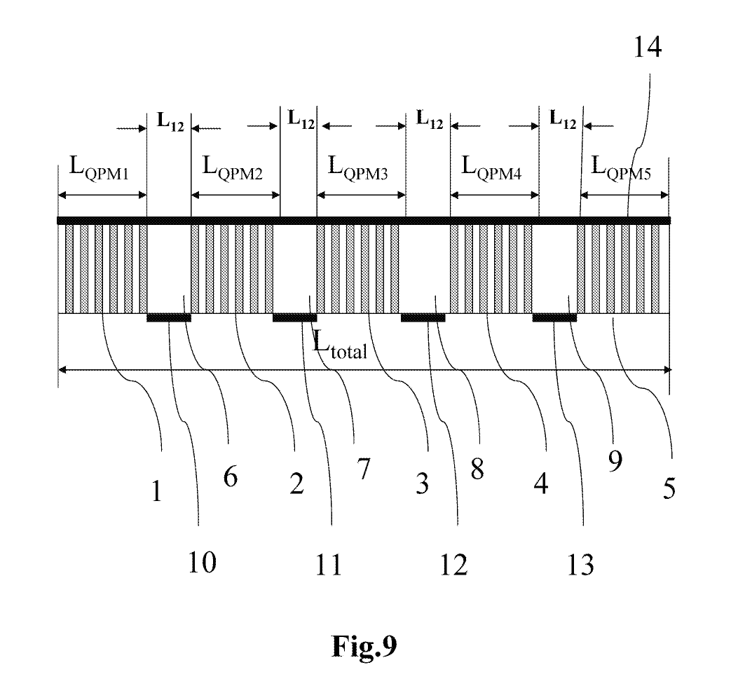

In the fourth preferred embodiment of the present invention, a method of forming an efficient nonlinear crystal with multiple QPM structures is presented, as shown in FIG. 8. In FIG. 8, a nonlinear crystal is formed by multiple sections 1-5 of MgO:PPLN (e.g. 5 sections) with different periods. The preferred length of each section is 2˜5 mm depending on number of sections used. Ideally the total length of the nonlinear crystal is less than 20 mm so that compact SHG laser can be achieved while simple laser cavity design can be maintained. The period of each section is determined by either the average temperature or SHG tuning curve of each section so that the QPM condition can be satisfied in each section and the difference of the QPM temperature (i.e. peak of the SHG tuning curve, at which SHG reaches maximum) between two adjacent sections is equal to the FWHM of the SHG tuning curve in each section. In the case of MgO:PPLN, if the length of each section is 2 mm, the temperature difference between the two adjacent SHG tuning curve is about 3° C., as shown in FIG. 8 (b). With these multiple QPM structures, temperature tolerance can be significantly enhanced (i.e. 5 times in the preferred embodiment), while SHG efficiency can be greatly enhance (i.e. 2˜4 times as compared with the case shown in the first preferred embodiment. To ensure SHG created in each section can be added together constructively, a phase adjustment section 6-9 is desirable, which can be inserted in between two adjacent sections, as shown in FIG. 8 (a). The phase adjustment sections are simply formed by leaving the area without crystal poling. The preferred length of the phase adjustment sections is less than 100 μm, depending on wavelength involved in SHG process, length of the QPM sections and operation temperature of the SHG laser. The optical length of the phase adjustment sections can be adjusted by electric fields across the phase adjustment sections, which are applied through electrodes 10-14, as shown in FIG. 9. Due the application of the electric fields, refractive index of the crystal between the electrodes is changed slightly. As a result, the optical length (i.e. product of refractive index and length) is tuned by the applied electric fields.

The above embodiments have described bonded MgO:PPLN nonlinear crystal for green laser with the intra-cavity configuration. Of course, the methods described in the present invention can be applied to other bonded nonlinear crystals such as MgO:PPLT, PPKTP, etc.

The above embodiments have described SHG green laser with the bonded nonlinear crystal and the intra-cavity configuration. Of course, the methods described in the present invention can be applied to other SHG lasers such as SHG blue lasers, etc.

The above embodiments have described SHG lasers using the bonded nonlinear crystal. Of course, the methods described in the present invention can also be applied to other optical nonlinear processes such as optical parametric oscillation, difference frequency generation, etc.

The above embodiments have described the design of nonlinear crystal with a bonded structure. Of course, the methods described in the present invention can also be applied to other optical nonlinear crystal without the bonded structure.

What is claimed is:

1. A method to design optimized length of a nonlinear crystal with a bonded structure used in SHG lasers with an intra-cavity configuration, in which a laser crystal is bonded directly with a nonlinear crystal.

2. The method according to claim 1, wherein the optimized length of the nonlinear crystal is determined by pumping power of the pumping laser diode, and scattering and absorption loss of the nonlinear crystal.

3. The method according to claim 1, wherein in case that MgO:PPLN nonlinear crystal is bonded with a Nd:YVO₄ laser crystal for a green SHG laser with an intra-cavity configuration, the optimized length of the MgO:PPLN nonlinear crystal is 1.0+/−0.5 mm for a pumping power of 500 mW at a wavelength of 808 nm.

4. The method according to claim 1, wherein the optimized period of a QPM nonlinear crystal is determined by the temperature at two ends of the bonded nonlinear crystal, in which the corresponding QPM temperature is equal to the temperature at the center of the QPM nonlinear crystal.

5. A method to form a short QPM crystal, in which the short QPM structure is sandwiched by un-poled nonlinear crystal, so that the overall length of the crystal is long enough to be handled in the standard polishing and bonding processes.

6. A method to design multiple-section periodically poled nonlinear crystal with a large temperature tolerance, while keeping sufficient long crystal length and thus high conversion efficiency.

7. The method according to claim 6, wherein the multiple-section periodically poled nonlinear crystal has different period for each section, which is decided by FWHM of SHG temperature tuning curve of each section.

8. The method according to claim 6, wherein the multiple-section periodically poled nonlinear crystal has a phase adjustment section between two adjacent QPM sections.

9. The method according to claim 6, wherein the optical length of the phase sections is tuned by electric fields across the sections, and the electric fields are applied through electrodes.
